(19) United States
(12) Patent Application Publication
(10) Pub. No.: US 2021/0270046 A1
(43) Pub. Date: Sep. 2, 2021

(54) REMOVABLE SQUARING SPACER FOR READY TO INSTALL DOOR SYSTEM

(71) Applicant: Larson Manufacturing Company of South Dakota, LLC, Brookings, SD (US)

(72) Inventors: Sara Wermers, Brookings, SD (US); Kole Kramer, Brookings, SD (US)

(21) Appl. No.: 17/186,308

(22) Filed: Feb. 26, 2021

Related U.S. Application Data
(60) Provisional application No. 62/983,082, filed on Feb. 28, 2020.

(51) Int. Cl. E04F 21/00

(52) U.S. Cl. CPC E04F 21/0023

(57) ABSTRACT

A ready-to-install door system including, prior to installation, a frame including a hinge-side vertical bar attached at a top end to a horizontal bar that is further attached to a top end of a latch-side vertical bar, and a threshold portion that is attached to a bottom end of the latch-side vertical bar and a bottom end of the hinge-side vertical bar, a door rotatably attached to the hinge-side vertical bar of the frame, and at least one first removable spacer located at a first location of the door between the door and the frame, and configured to at least maintain a desired squareness of the door system prior to installation, wherein the first removable spacer is configured to be removed after the door system is installed.

### CROSS-REFERENCE TO RELATED APPLICATIONS

This application claims the benefit of U.S. Provisional Patent Application No. 62/983,082, filed Feb. 28, 2020 and titled “REMOVABLE SQUARING SPACER FOR READY TO INSTALL DOOR SYSTEM” the entire contents of which are incorporated herein by reference in its entirety.

### FIELD OF THE DISCLOSURE

This disclosure relates to a quick-install door system, such as a storm door system, and components thereof.

### SUMMARY OF THE DISCLOSURE

Briefly, the present disclosure provides for ready-to-install door systems, methods of installing said systems, and various components thereof and/or related thereto. In particular, the present disclosure provides for door systems, assemblies, and related installation thereof, doors, door frame, and one or more removable squaring spacers that are positioned within the door system in order to assist in maintaining a squareness of a door system during shipping, or before or during installation. It is not desirable for a door system to be installed without proper squareness for various reasons.

In some existing systems, a type of spacer can be used to intentionally “rack” a door system out of square in order to compensate for sag or flex, such as during installation. However, the present disclosure relates to spacers that instead do the opposite, and maintain at least the integrity and squareness of the ready-to-install door system, and do not deliberately rack the system. Instead, the disclosed spacers avoid racking the system to allow an easier and more consistent installation of a protected and relatively undamaged and easy to operate door system. The spacers described herein also can provide other functionality and benefits in various embodiments.

It is an advantage of the present disclosure to provide a door system including at least one removable spacer. The door system may be installed rapidly, typically in less than ten minutes, and simply, typically with only a screwdriver, with screws accessible from only the front side of the system.

### BRIEF DESCRIPTION OF THE DRAWINGS

FIG. 1 is a front elevation view of an example door system, according to various embodiments.

FIG. 2 is a front elevation view of a door system with a desired squareness.

FIG. 3 is a front elevation view of a door system with an existing result and without a desired squareness.

FIG. 4 is a vertical cross-sectional view of the door system of FIG. 1 taken along section line A-A with the door in a closed position and showing a first embodiment of a first removable spacer, according to various embodiments.

FIG. 5 is a vertical cross-sectional view similar to FIG. 4, but with the door in an open position, where the sill transition and the first embodiment of the first removable spacer are in a lowered position, according to various embodiments.

FIG. 6 is a vertical cross-sectional view of the door system of FIG. 1 taken along section line A-A with the door in a closed position and showing a second embodiment of a first removable spacer, according to various embodiments.

FIG. 7 is a vertical cross-sectional view similar to FIG. 6 but with the door in an open position, where the sill transition and the second embodiment of the first removable spacer are in a lowered position, according to various embodiments.

FIG. 8 is a side elevation view of the first embodiment of the first removable spacer, according to various embodiments.

FIG. 9 is a side cross-sectional view of a third embodiment of the first removable spacer, according to various embodiments.

FIG. 10 is a vertical cross-sectional view of the door system of FIG. 1 taken along section line B-B and showing a second removable spacer, according to various embodiments.

FIG. 11 is a vertical cross-sectional view of a door system, showing the second removable spacer in an expanded position, according to various embodiments.

FIG. 12 is a front elevation view of a door system with one removable spacer located near a hinge-side and threshold portion, according to various embodiments.

FIG. 13 is a front elevation view of a door system with one removable spacer located near a latch-side and threshold portion, according to various embodiments.

FIG. 14 is a front elevation view of a door system with one removable spacer generally centered and located near a threshold portion, according to various embodiments.

FIG. 15 is a front elevation view of a door system with one removable corner spacer located near a hinge-side and threshold portion, according to various embodiments.

FIG. 16 is a front elevation view of a door system with one removable corner spacer located near a latch-side and threshold portion, according to various embodiments.

FIG. 17 is a front elevation view of a door system with two removable spacers located near a latch-side and threshold portion and near a latch-side and horizontal bar, according to various embodiments.

FIG. 18 is a front elevation view of a door system with two removable spacers located near a hinge-side and threshold portion and near a hinge-side and horizontal bar, according to various embodiments.

FIG. 19 is a front elevation view of a door system with two removable spacers located near a center of the threshold portion and near a center of the horizontal bar, according to various embodiments.

FIG. 20 is a front elevation view of a door system with two removable spacers located near a center of the threshold portion and near a location at the horizontal bar other than a center of the horizontal bar, according to various embodiments.

FIG. 21 is a front elevation view of a door system with two removable corner spacers located near a hinge-side and threshold portion and near a hinge-side and horizontal bar, according to various embodiments.

FIG. 22 is a front elevation view of a door system with two removable corner spacers located near a latch-side and threshold portion and near a latch-side and horizontal bar, according to various embodiments.

FIG. 23 is a front elevation view of a door system with two removable corner spacers located near a hinge-side and threshold portion and near a latch-side and threshold portion, according to various embodiments.

FIG. 24 is a front elevation view of a door system with two removable spacers located near a hinge-side and threshold portion and near a latch-side and threshold portion, according to various embodiments.

FIG. 25 is a front elevation view of a door system with three removable spacers located near a hinge-side and threshold portion, near a latch-side and threshold portion, and near a latch-side and horizontal bar, according to various embodiments.

FIG. 26 is a front elevation view of a door system with three removable corner spacers located near a hinge-side and threshold portion, near a latch-side and threshold portion, and near a latch-side and horizontal bar, according to various embodiments.

FIG. 27 is a front elevation view of a door system with four removable spacers located near a hinge-side and threshold portion, near a latch-side and threshold portion, near a hinge-side and horizontal bar, and near a latch-side and horizontal bar, according to various embodiments.

FIG. 28 is a front elevation view of a door system with four removable corner spacers located near a hinge-side and threshold portion, near a latch-side and threshold portion, near a hinge-side and horizontal bar, and near a latch-side and horizontal bar, according to various embodiments.

### DETAILED DESCRIPTION

The present disclosure provides an at least partially pre-assembled and ready-to-install, quick-to-install door system and various optional components thereof. The disclosed ready-to-install door systems and methods provide installation advantages when compared to, for example, a conventional or traditional residential storm door installation kit. Typically, residential storm doors are not shipped as pre-hung door assemblies. Furthermore, there are many challenges and shortcomings related to pre-hung door/frame combinations.

Applicant hereby incorporates by reference commonly-owned U.S. application Ser. No. 16/555,654, filed on Aug. 29, 2019, which claims the benefit under 35 U.S.C. § 119(e) of U.S. Provisional Patent Application No. 62/724,327, filed on Aug. 29, 2018, entitled “Ready to Install Door System,” U.S. Provisional Patent Application No. 62/898,902, filed on Sep. 11, 2019, entitled “Ready to Install Door System,” U.S. patent application Ser. No. 17/018,939, filed on Sep. 11, 2020, entitled “Building Systems and Methods for Installing Building Systems Relative to Building Openings,” U.S. patent application Ser. No. 17/090,070, filed Nov. 5, 2020, entitled “Building Systems and Methods for Installing Building Systems Relative to Building Openings,” and U.S. patent application Ser. No. 17/090,109, filed Nov. 5, 2020, entitled “Building Systems and Methods for Installing Building Systems Relative to Building Openings,” for all purposes herein.

The installation of embodiments of the present door system and assembly is quicker and more efficient than existing and available options. The present embodiments also beneficially accommodate a wider variety of installation variables and conditions. In some embodiments, pre-assembly of a door closer and lockset in the door system avoids the time-consuming steps of separate assembly and installation processes required by a conventional kit. In addition, the disclosed pre-assembled door system allows the installer to easily position and hang the door system in a framed door opening in a single operation. For these and other reasons, even an installer with limited installation experience can easily install the door system. Embodiments of the present disclosure further include integrated removable load-bearing, positioning, stabilizing, and/or force damping features, such as spacers, that make installation more consistent and easier with respect to an existing primary door and/or primary door sill. In this disclosure, all the components for installation of a door system can be properly positioned in a single positioning step of the entire door system.

Further, pre-loading installation screws in screw holding channels prior to shipment and including door assembly supports below a threshold portion allows the installer to quickly drive the screws from the readily accessible front or “face” of the door system. Other embodiments include a door assembly that is configured to fit within a recessed primary door, and can include installation screws that are installed at a transverse, 90-degree angle to the face of the existing or primary door system.

An optional cover can then conceal the screws once they are driven in and tightened to arrive at the tightened position. Still further, pre-assembly of the door system substantially ensures the system components remain properly aligned with respect to each other during the installation. Proper alignment of the system components avoids the potential of binding or other problems, for example, of the door opening, closing, latching, and sealing. These and other improvements to ready-to-install door system assemblies are described herein.

As described herein, one or more removable spacers can be incorporated into the door system as shipped. Such removable spacers can be used to support a door relative to its corresponding frame during shipping and maintain a squareness of at least the door and frame relative to each other. The removable spacer can further be configured to be either automatically or manually removable after installation of the door system. The removable spacers are selected or configured to reduce unwanted flex, sag, and/or racking of the various components of the door system, particularly prior to installation. According to various embodiments, the one or more removable spacers can separately or additionally internally absorb or dampen impacts that would otherwise detrimentally impact the various components, for example, during shipping and/or transport of the door system or a plurality of door systems. In yet further embodiments, the one or more spacers can additionally or alternatively be configured to hold a door sill transition and/or extender upright in a shipping or installation position (e.g., generally parallel with the door) until the spacer is removed.

According to various embodiments, one or more spacers can be utilized during shipping and/or installation to support and dampen the assembled components of the ready-to-install door system. The removable spacers can be substantially rigid in certain embodiments (e.g., a supporting spacer), or can be substantially compliant (e.g., a damping or spring spacer), or any variation or combination thereof. Flexibility and/or rigidity can be selected and/or configured for each removable spacer by selecting materials with certain characteristics, providing the spacers in relatively rigid or flexible shapes, or a combination of the above.

According to certain embodiments, there can be a first type of spacer that is located e.g., near a bottom of a door, and a second type of spacer than is located e.g., next to a top of the door. In order to assist supporting the door relative to the frame, the first type of spacer can be referred to as a supporting, load-bearing, or lower spacer. Likewise, in order to dampen impacts, take up manufacturing tolerances, and/or protect adjacent components of a door system before, during, or after shipping, and before or during installation, the second type of spacer can be referred to as a damping, spring, or upper spacer. In various embodiments, the supporting spacer and the damping spacer can be used together or separately with a single door system, and can be configured to guide and space the door relative to the frame of the door system. Both the supporting and damping spacers can be squaring spacers having additional function and/or features as described herein. In yet other embodiments, squaring spacers can be utilized that are neither supporting nor damping spacers.

Regarding positioning of various removable spacers, many different embodiments are contemplated herein. In some embodiments, one or more supporting spacers can be used with or without one or more damping spacers. In some embodiments both types of spacers are employed, and in yet further embodiments two supporting spacers and two damping spacers are employed for a single door system prior to installation. Any combination of spacers can be used according to various embodiments.

According to various embodiments, various removable spacers described herein can be located at or near door corners or edges and/or edges or corners of the frame.

Installation of the door system, with the spacers still in the shipping position, to an existing door frame/doorway causes the squareness of the door system components relative to each other to be maintained, even after the spacers have been removed. After installation of a door system that includes removable spacers as described herein, a user can open the door that is attached to the frame. Upon opening the door, one or more of the spacers can fall out, or otherwise be removed from the shipping position. In some cases, the movement of the door as it swings open will cause or force one or more spacers to be dislodged or unseated, which can lead to the spacers either becoming loosened or by being removed entirely, e.g., so that the spacers fall to the ground.

Where a sill transition is present, it is possible that the sill transition may be held by a supporting spacer even once the door is opened after installation. In some cases, a user pulling down on the sill transition can cause the supporting spacer to become removed or removable. In some cases, the door may be opened prior to a deployment or downward rotation of the sill transition, and upon a user deploying the sill transition (e.g., rotating it down), and then the supporting spacer can become removed or removable by the user. In some embodiments, the sill transition and the supporting spacer can be pivoted into position together, where the user removes the spacer from the sill transition after the sill transition is fully deployed. In some embodiments, the spacer is released to fold or pivot with the sill transition when the door is swung at least partially open.

As discussed above, a supporting spacer is also referred to herein as a first removable spacer. Supporting spacers can be a type of removable squaring spacers that can maintain a squareness of a door relative to a frame, particularly prior to and during installation. This can reduce or prevent racking, which is where a door or frame loses a squareness, integrity, or relative perpendicularity of top/bottom (horizontal) portions relative to latch/hinge (left/right or vertical) sides of various components. A supporting spacer can be a removable squaring spacer that is substantially rigid in certain embodiments, e.g., sufficiently rigid to not significantly deform under the weight of a door, e.g., a door with a transparent or glass panel as described herein. In other embodiments the supporting spacer can be at least partially flexible, compliant, or compressible. The supporting spacer can be configured to at least partially bear a weight of a door of the door assembly. In some embodiments, multiple supporting spacers are used as a pair along a single edge, where each supporting spacer bears only a portion of the door weight.

Each supporting spacer can include two or more portions, which can be or otherwise include one or more spacer extensions or “legs.” Therefore, the portions themselves can each include one or more legs corresponding to a threshold portion, i.e., “threshold leg(s)” and one or more legs corresponding to a sill transition portion, i.e., “sill transition leg(s)” of a corresponding door. In an embodiment, a threshold leg can be substantially parallel to the threshold portion and a sill transition leg can be substantially parallel to the door sill transition when the door assembly is in the installation or shipping position and the sill transition is substantially vertical in the installation position. In some embodiments, the supporting spacer may include additional portions or legs that can reinforce or strengthen another leg, or can provide additional spacing functionality. Yet additional portions or legs can be included as contemplated herein.

In an exemplary embodiment, a threshold leg and a sill transition leg of a supporting spacer are preferably oriented substantially perpendicular to each other. The threshold leg of the spacer can include three or more legs in some embodiments, including two legs protruding toward the threshold portion and a third leg protruding away from the sill transition portion and toward a portion of the door in order to reduce movement of the various components with the spacer in place. Therefore, the supporting spacer can provide two supporting structures in a single removable spacer, wherein the supporting structures provide transverse and longitudinal support in multiple directions. The directions can be perpendicular, substantially perpendicular, or at least partially perpendicular. Each “leg” described herein can include one or more “feet,” which can be sub-legs or portions of each leg. The threshold leg can include two lower feet and a third spacing foot that is located on a side of the threshold portion opposite the sill transition.

In an exemplary embodiment, a threshold leg can extend between or proximate a bottom frame member of the frame and a bottom frame seal of the threshold portion or door sill and below the door panel of the door. In some embodiments, the supporting spacer, when placed in position, can cause the bottom frame seal of the door sill to compress temporarily until the supporting spacer is removed after installation. In other embodiments, such as a two-legged embodiment, a first leg can make an oblique angle to a second leg.

In an exemplary embodiment, a sill transition portion of a supporting spacer can comprise a clip feature that at least partially surrounds an outermost or distal end of a deployable sill transition, and can further include a tab that interfaces with a recess in the sill transition. In an installation position, the sill transition portion of the supporting spacer is also substantially parallel to the door. The relative rigidity or flexibility of the supporting spacer can be a function of the materials, shape, and/or structural aspects of the supporting spacer.

In some embodiments, the supporting spacer has a threshold leg that has one or more non-linear bends or undulations that permit additional compliance, particularly in a horizontal direction (e.g., forward-backward relative to face of door). The bends can also create an integrated vertical support (e.g., up and down relative to face of door) by increasing a size in a vertical dimension, without requiring additional vertically-oriented legs or portions.

The supporting spacer can be located between a door panel of the door system and a threshold portion of the frame or any other suitable location.

As discussed above, a damping spacer is also referred to herein as a second removable spacer. Example damping spacers can be squaring spacers. Squaring spacers can maintain a squareness of a door relative to a frame, particularly prior to installation. This can reduce or prevent racking, which is where a door or frame loses a squareness or relative perpendicularity of top/bottom (e.g., horizontal bar, drip cap, or threshold portions) portions relative to latch/hinge (e.g., hinge-side or latch-side vertical bars) sides of various components. Sometimes during shipment, transportation, positioning, and/or installation, there are shocks or sudden forces applied to a ready-to-install door system. This can be problematic, such as leading to damage to various parts of the door system. In some embodiments of ready-to-install door systems, one or more supporting spacers can be supplemented with one or more damping spacers. When used within a door system prior to installation, a damping spacer can preferably be located near a top of the door and/or frame. Damping spacers can additionally or alternatively be used on other portions of the door before installation, such as sides and/or bottom of the door.

In an exemplary embodiment, a damping spacer can have a U-shaped spring portion that allows for a vertical (or longitudinal, depending on the door orientation) damping, absorption, and/or spring effect. It is understood herein that the damping of the damping spacer can describe a spring, flexible, compliant, or elastic characteristic, and need not be a purpose-built damper apparatus. The relative rigidity or flexibility of the damping spacer can be a function of the materials, shape, and/or structural aspects of the damping spacer. Although a leaf-spring like U-shaped section can effectively provide a damping or spring effect, other shapes and configurations are also contemplated herein. A resting shape of an embodiment of a damping spacer can be a U-shape with a positive angle between two segments of the damping spacer. A substantially flat, positioning flange portion of the damping spacer can be attached to the U-shaped damping portion, and the positioning portion can be configured to interface with the door and/or frame in order to help hold the damping spacer in place during shipment and/or installation. Although the damping of the damping spacer can be longitudinal to the door length, a transverse damping or spring function can also be included in the damping spacer.

In an exemplary embodiment, one or more damping spacers can be located between a door panel of the door and a top horizontal bar of the frame or any other suitable location. In some embodiments, the damping spacer can be compressed and/or can compress one or more portion of the door and/or frame.

As shown and described with reference to the present disclosure, certain embodiments of removable spacers can be considered “corner” spacers. Spacers as used herein can be corner-type spacers or otherwise. Other types of non-corner spacers can include spacers that specifically operate in a vertical, horizontal, or are otherwise not located at a corner of an object to be spaced, such as a door. A corner spacer can in particular interface with a corner of a door of a door system such that the spacer is located at or near the corner and can provide spacing in two directions that are e.g., perpendicular to each other. In other words, a corner spacer can provide spacing both horizontally and vertically at least due in part to the corner position and/or corner shape of the corner spacer.

While some exemplary embodiments are described in detail herein, alternate embodiments may also serve to accomplish the same or similar benefits and/or results. For example, in one embodiment, a latch or deadbolt may be extended from a handle and latch hardware set installed in the door toward the latch-side vertical bar, and supported by a structure removably fastened to the latch-side vertical bar at the preferable vertical location that positions the door within the frame such that the desired squareness of the door system is maintained. In another embodiment, a removable squaring spacer may be positioned between the door panel and the latch-side mounting frame, near the upper latch-side corner of the door panel that maintains the desired squareness of the door system. In another embodiment, a bracket may be removably fastened to both the latch-side edge of the door and the latch-side vertical bar, or to both the top edge of the door and the horizontal bar, or two brackets may be removably fastened to both the latch-side edge of the door and the latch-side vertical bar and to both the top edge of the door and the horizontal bar, such that the desired squareness of the door system is maintained.

In another embodiment, a single squaring spacer may be positioned between the door panel and the threshold portion at a location approximately midway between the bottom latch-side and bottom hinge-side corners of the door and frame. In another embodiment, one or more lengths of a semi-rigid material may be inserted between one or more edges of the door and one or more of the horizontal member, latch-side vertical member, and threshold portion, in which the semi-rigid material is flexible enough to be inserted between the door and adjacent frame members yet rigid enough to maintain a desired squareness of the door system.

In another embodiment, a rigid, 90-degree corner bracket is fastened to one or more of the external corners of the frame of the ready-to-install door system such that frame is held in a square position while hinges that rotatably connect the door to the hinge-side vertical bar hold the door in the desired horizontal and vertical positions such that the desired squareness of the door system is maintained. In still another embodiment, a top end of a structure that connects the threshold portion of the frame to the bottom end of the latch-side vertical bar supports a structure that extends vertically downward between the door and the frame until reaching a segment that extends at a 90-degree angle under the lower latch-side corner of the door, such that the segment that extends at a 90-degree angle under the door supports the door and maintains the desired squareness of the door system.

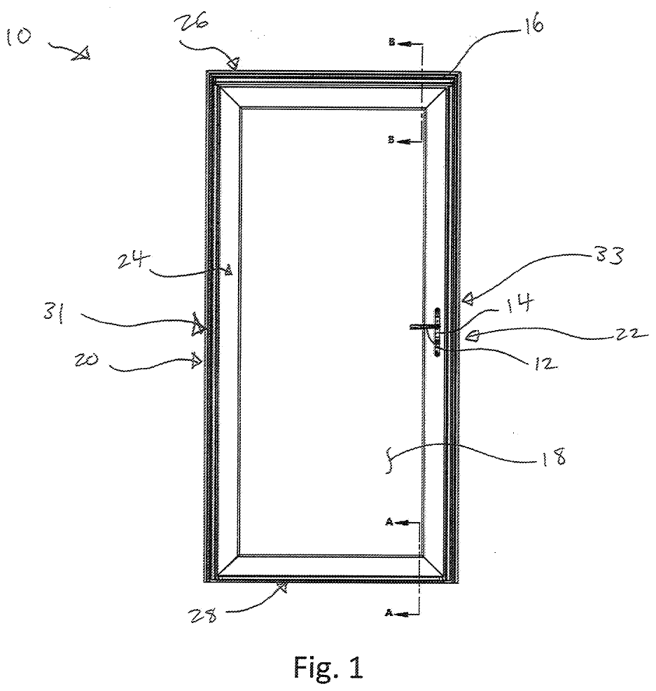

Referring now to the Figures, wherein the components are labeled with like numerals throughout the several Figures, and initially to FIG. 1, one exemplary embodiment of a door system according to the present disclosure comprises a ready-to-install door assembly 10. Door assembly 10 includes a door 24, and a frame 26, which includes a hinge-side vertical bar 31, a latch-side vertical bar 33, a horizontal bar 16, a threshold portion 28. Door assembly 10 can also include various other components not shown, such as a door closer with a closer arm. Door assembly 10 can be a ready-to-install storm door assembly (e.g., a system) that can be installed to or next to an existing door frame assembly, e.g., corresponding to a primary door.

The door 24 is pivotably attached to the hinge-side vertical bar 33 by one or more hinge assemblies attached to the door 24. A door closer (not shown) can be attached to the door 24 and the horizontal bar 16 (e.g., a drip cap) or the door 24 and the hinge-side vertical bar 31 according to various embodiments. In some embodiments, the horizontal bar 16 is attached to a top portion of the latch-side vertical bar 33, to a top portion of the hinge-side vertical bar 31, and to a door closer.

The door 24 as shown includes a transparent panel 18. However, the door 24 can also be selected from the group consisting of (but not limited to): a storm door, a screen door, a security screen door, a configurable door with an interchangeable portion, a security door with bars, and a security door with laminated glass. According to various embodiments, the interchangeable portion of the configurable door is selected from the group consisting of: full view glass, partial-view glass, full screen, partial screen, laminated glass, security bars, security mesh, and a combination of glass and screen. The door 24 can be a residential storm door, a light commercial storm door, or a heavy commercial storm door, among other types of doors.

As shown, the door 24 includes a lockset 14 and a handle 12 located near a latch side 22 of the door assembly 10 opposite the hinge-side 20. The handle 12 can actuate a latch feature of the lockset 14, and can optionally actuate a “three-point lock” hook-and-pocket securement via hooks and/or pockets (not shown). As shown the handle 12 is a lever-style handle, but a door knob, or any other handle can optionally be substituted in place of the lever-style handle 12. The horizontal bar 16 of the frame 26 can be a drip cap that includes a drip channel that is configured to operate as a gutter, in order to channel water to the sides of the door 24, thereby reducing dripping on a user when passing through the door assembly 10.

The door 24 is pivotably attached to the hinge side 20 of the door assembly 10. The door 24 can be attached to the hinge side 20 with one or more hinges and optionally by door closer hardware, including a door closer with a closer arm. If included, the closer arm can be a single-segment closer arm or a multi-segment closer arm in various embodiments. In some embodiments, closer hardware is as described in one or more of the following U.S. patent applications, incorporated herein by reference: Ser. No. 15/382,275 (issued on Sep. 15, 2020 as U.S. Pat. No. 10,774,570); Ser. No. 15/911,639 (issued on Oct. 13, 2020 as U.S. Pat. No. 10,801,241); Ser. No. 15/911,690 (issued on Oct. 13,2020 as U.S. Pat. No. 10,801,242); Ser. Nos. 15/385,091; and 16/914,850.

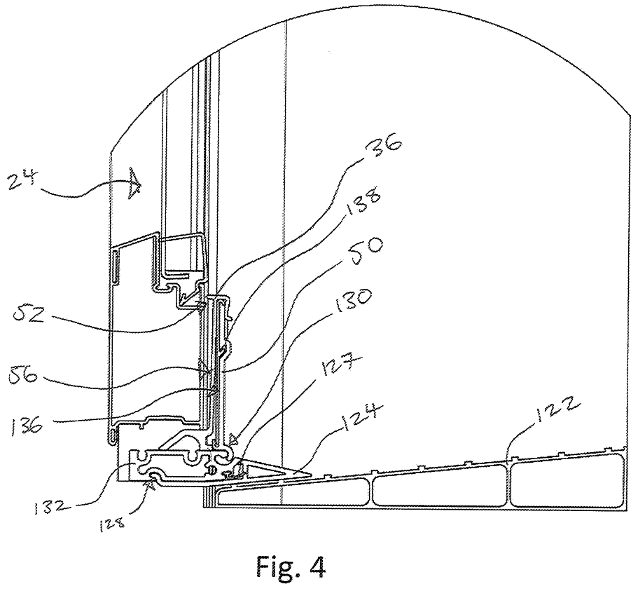

Referring additionally to FIGS. 4-8 and as is described in U.S. Provisional Patent Application No. 62/898,902, filed on Sep. 11, 2019, entitled “Ready to Install Door System,” and U.S. patent application Ser. No. 17/018,939, filed on Sep. 11, 2020, entitled “Building Systems and Methods for Installing Building Systems Relative to Building Openings,” as incorporated by reference herein, the threshold portion 28 of the frame 26 includes at least one pivotable sill transition 50, which can further include one or more sill extenders 136 that can be adjustable and/or trimmed to fit a primary door sill, a primary door frame, etc. When such sill extender(s) 136 are provided, they may be provided as a single piece or multiple pieces in various embodiments. In one embodiment, the sill extender(s) 136 can be attached to pivotable sill transition 50 via a sill extender attachment point 138, which can include a transverse groove that runs along a width of the sill transition 50. A snap-fit engagement can provide a secure fit of the sill extender 136 to the sill transition 50. It is understood, however, that any provided sill transition(s) 50 can be configured for attachment in a number of different ways to any provided sill extender(s) 136, depending on the provided features of each component.

In order to maintain the sill transition 50 in a generally vertical position during installation of the door assembly 10, at least one removable spacer 36 can be installed at a lower end of the door assembly 10 prior to shipment to act as a supporting, load bearing, or lower spacer. During transit or handling of the door assembly, the door assembly and corresponding sill transition can be in a number of orientations, any of which include the sill transition being generally parallel to the door. The removable spacer 36 can be located proximate the sill transition 50 (i.e., at or near a lower portion of the door), as shown. The removable spacer 36 can include one or more sill transition attachment features, such as clips, interference tabs, notches, snaps, protrusions, ribs, or any other suitable structure for secure, yet removable attachment of the removable spacer 36 from the sill transition 50 when it is desirable to do so.

Removable spacer 36 further serves the purpose of maintaining a squareness of door 24 relative to frame 26, particularly prior to and during installation. This can reduce or prevent racking, which is where a door or frame loses a squareness, integrity, or relative perpendicularity of top/bottom (horizontal) portions relative to latch/hinge (left/right or vertical) sides of various components. Spacer 36 can be substantially rigid in certain embodiments, e.g., sufficiently rigid to not significantly deform under the weight of door 24. In other embodiments the spacer 36 can be at least partially flexible, compliant, or compressible. Spacer 36 can be configured to at least partially bear a weight of door 24 of the door assembly 10. In some embodiments, multiple spacers 36 can be used as a pair along a single edge, where each spacer 36 bears only a portion of the door weight.

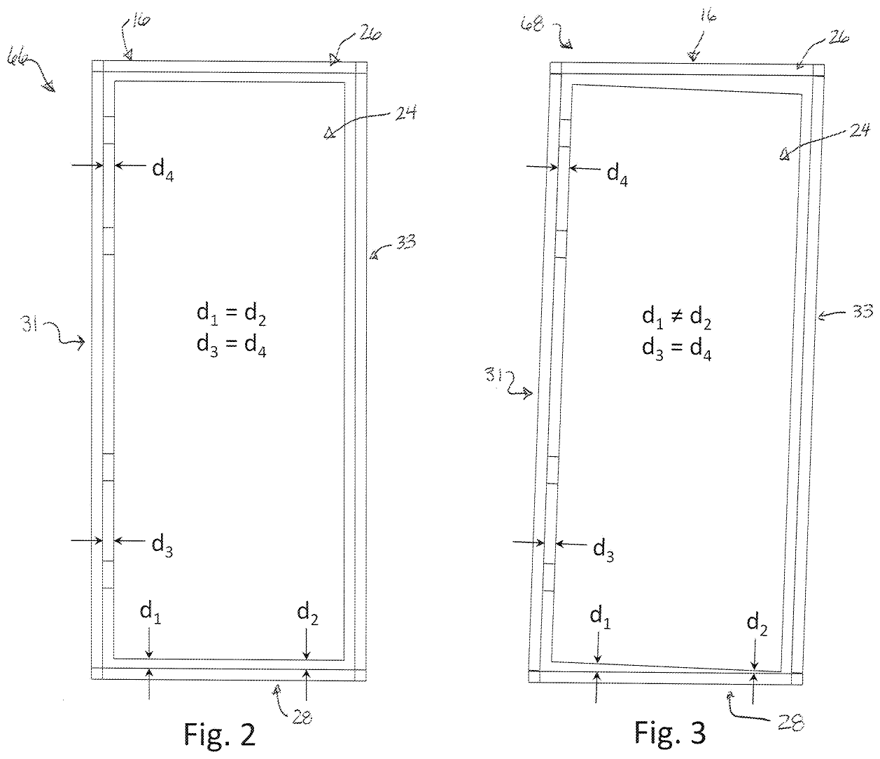

With particular reference to FIGS. 2 and 3, FIG. 2 illustrates a desired result 66 with desired squareness of the door 24 relative to the frame 26, and FIG. 3 illustrates an undesired result 68 with the door 24 and frame 26 being out of square relative to each other. In further detail, according to FIG. 2, various spacing distances between door 24 and frame 26 are represented by measurements d₁, d₂, d₃, and d₄. Additionally, d₁, d₂, d₃, and d₄ are shown with d₁ and d₂ spaced apart along the hinge side vertical bar 31, and d₃ and d₄ spaced apart along the threshold portion 28. As shown, it is desirable that d₁=d₂, and d₃=d₄. Therefore, a preferred example of squareness can be defined as shown with reference to desired result 66 of FIG. 2.

In FIG. 3, either the frame 26 or a portion of the door 24 is racked. Racked components can in some embodiments lack squareness, and can negatively affect installation and/or operation of the door assembly 10. As shown, d₃=d₄, but d₁≠d₂. Therefore, existing result 68 of FIG. 3 illustrates an example of an undesirable lack of squareness. In other existing and undesirably racked results, d₁=d₂, and d₃≠d₄, or d₁≠d₂, and d₃≠d₄. Those skilled in the art would understand that racking of frame 26 and/or door 24 components can occur in practice, and can be measured or determined in diverse ways.

Referring again to FIG. 4, a cross section view is illustrated of a primary door sill 122 with a door assembly support 124 inserted into a sill frame 132 and sill transition 50 in a vertical (e.g., installation) position. Spacer 36 is also shown proximate the sill transition 50. The door assembly support 124 can be shipped, provided, or packaged separately and uninstalled from the door assembly 10. In some embodiments, the door assembly support 124 can be inserted into the sill frame 132 to create a pivoting hinge feature 128 that allows for a secure, but dihedral rotatable attachment of the door assembly support 124 to the sill frame 132. The hinge feature 128 of the door assembly support 124 can be configured such that the door assembly support 124 does not disengage from the sill frame 132 once rotated.

A flexible transition leaf 127 can be positioned below and attached to a bottom portion of the sill frame 132. When the door assembly support 124 is rotated into place, the door assembly support 124 can contact and press against the transition leaf 127. The transition leaf can be formed of a flexible and/or elastomeric material, and can operate to provide a secure, dampened fit between the sill frame 132 and the door assembly support 124. The transition leaf 127 can be compressed when the door assembly 10 is installed to assist in the installation process. In particular, as the door assembly support 124 is rotated (e.g., counterclockwise, relative to the illustrated embodiment) from a near-vertical installation position into the position illustrated, an angled portion at the end of the door support assembly 124 will deflect or compress the leaf 127 at least slightly so that the door support assembly can pass by it. The leaf 127 can then “decompress” or move back toward its original configuration. In this way, the leaf 127 will prevent the door support assembly 124 from freely rotating (e.g., clockwise, relative to the illustrated embodiment) under its own weight and fall out of the sill frame 132 when while the door is being positioned on the primary door sill 122.

The vertical, “installation” position of the sill transition 50 can be such that the sill transition 50 begins adjacent to door 24. The sill transition 50 can be rotated down via a hinge feature 130 toward and such that contact is made with the primary door sill 122. This contact can cause the sill transition to rest on the primary door sill 122 such that a user can walk seamlessly from the primary door sill 122 to the sill transition 50 to the threshold portion 28 of the door assembly 10 without significant encumbrance and with minimal topographical movement or undulation. The hinge feature 130 of the sill transition 50 can be configured such that the sill transition 50 does not fall off the sill frame 132 when rotated at various angles.

As shown with reference to FIG. 4, spacer 36 is shown positioned adjacent the sill extender 136 and the sill frame 132. The spacer 36 can include a clip feature 52 that can optionally be flexible and can hold the sill transition 50 and/or sill extender 136 in an installation, vertical position before the first spacer 36 is removed. The clip feature 52 is generally U-shaped so that it at least partially surrounds an outermost or distal end of sill transition 50, and can further include a tab that interfaces with a recess in the sill transition 50.

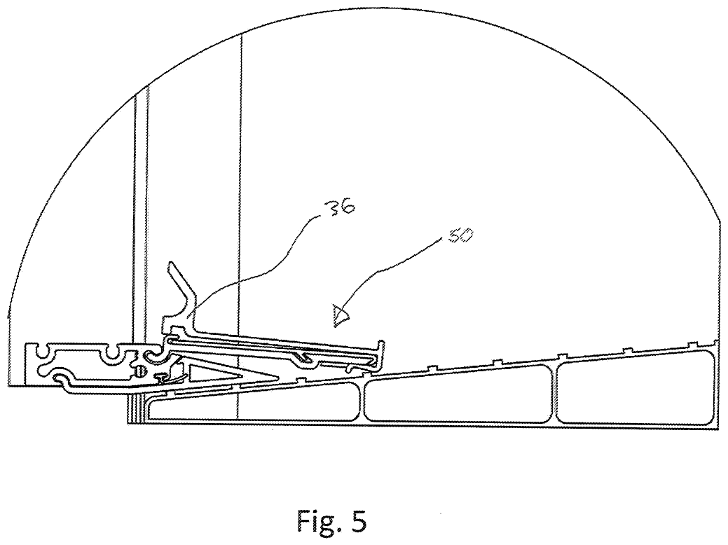

FIG. 5 shows the components of FIG. 4 with the sill transition 50 and the first removable spacer 36 in a lowered position, according to various embodiments. The first removable spacer 36 can remain attached to the sill transition 50 as it is moved to the lowered position. In other embodiments, the first removable spacer 36 can become removed from the sill transition 50 upon a lowering of the sill transition 50. In embodiments, the first removable spacer 36 can be manually removable by a user, e.g., by hand, or can eject or automatically self-remove upon an occurrence, such as the lowering of the sill transition 50 to the lowered position. Removable spacer 36 is preferably to be used at or near a bottom of the door assembly 10, although it can also be used in other locations of the door assembly 10. The sill transition 50 can self-deploy into the lowered position when the door 24 is rotated open and no longer traps the spacer 36 between the sill frame 132 and the bottom of the door 24.

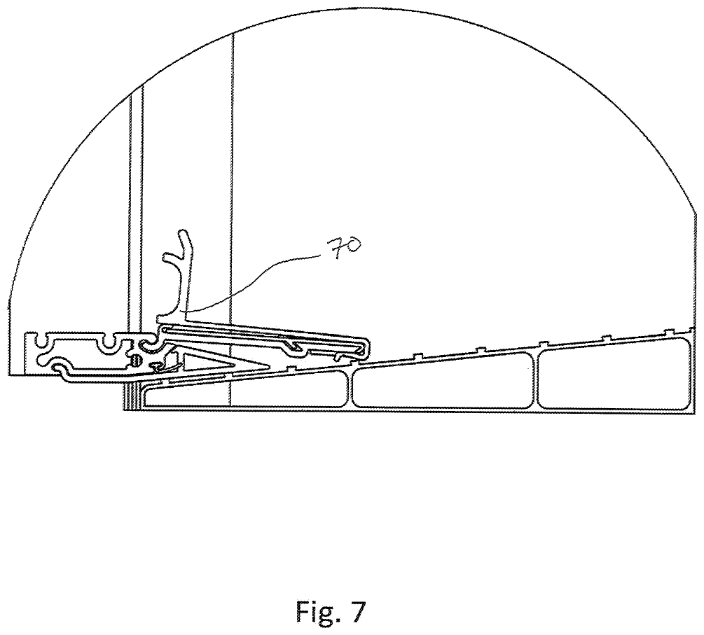

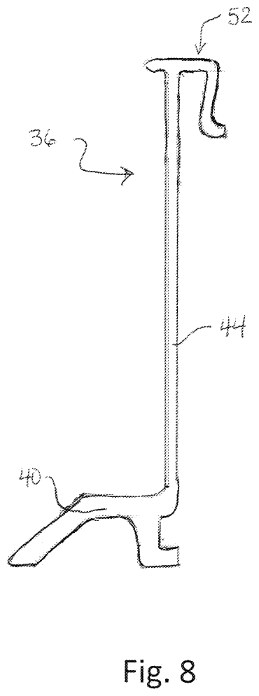

FIG. 8 shows in greater detail a schematic view of one exemplary embodiment of removable spacer 36. Spacer 36 can include two or more portions, which can be or otherwise include one or more spacer extensions or “legs.” In an embodiment, spacer 36 includes a threshold leg 40 that can be substantially parallel to a threshold portion of a door, and a sill transition leg 44 that can be substantially parallel to the sill transition when the door assembly is in the installation or shipping position and the sill transition is substantially vertical in the installation position. In some embodiments, the spacer 36 may include additional portions or legs that can reinforce or strengthen another leg, or can provide additional spacing functionality. Yet additional portions or legs can be included as contemplated herein. As shown, clip portion 52 is located at an end of sill transition leg 44.

In this embodiment, threshold leg 40 and sill transition leg 44 are preferably oriented substantially perpendicular to each other. Threshold leg 40 can include multiple extending legs in some embodiments, such as two legs protruding toward the threshold portion and a third leg protruding away from the sill transition portion and toward a portion of the door in order to reduce movement of the various components with the spacer 36 in place, for example. That is, the spacer 36 can provide two supporting structures in a single removable spacer, wherein the supporting structures provide transverse and longitudinal support in multiple directions. The directions can be perpendicular, substantially perpendicular, or at least partially perpendicular. Each “leg” described herein can include one or more “feet,” which can be sub-legs or portions of each leg. The threshold leg can include two lower feet and a third spacing foot that is located on a side of the threshold portion opposite the sill transition.

In an exemplary embodiment, threshold leg 40 can extend between or proximate a bottom frame member of the frame and a bottom frame seal of the threshold portion or door sill and below the door panel of the door. In some embodiments, the spacer 36, when placed in position, can cause the bottom frame seal of the door sill to compress temporarily until the spacer 36 is removed after installation. In other embodiments, such as a two-legged embodiment, a first leg can make an oblique angle to a second leg.

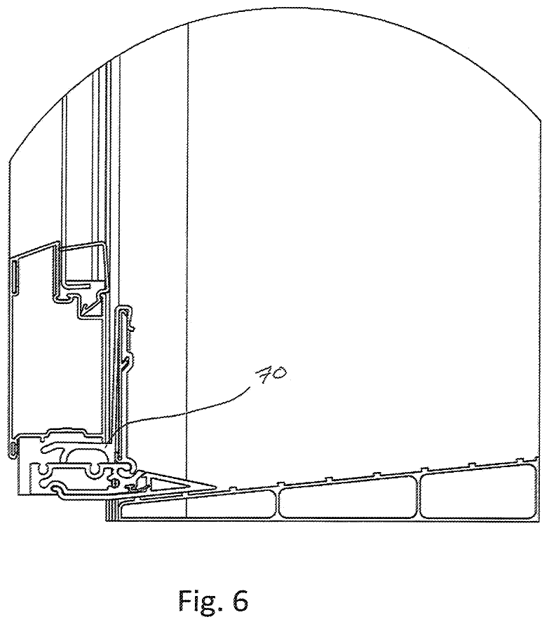

FIGS. 6 and 7 are similar to FIGS. 4 and 5, and are likewise representative of a vertical cross-section view taking along section A-A of FIG. 1. However, FIGS. 6 and 7 illustrate an alternate embodiment of a removable spacer 70. The removable spacer 70 has a three-leg configuration, and includes two legs facing the threshold portion and a third leg that faces a direction that is generally perpendicular to the first and second legs. The third leg in the removable spacer 70 may have different spacing and/or strength characteristics as compared to removable spacer 36. All features and functional capabilities of removable spacer 36 are optionally present in removable spacer 70. Removable spacer 70 is preferably to be used at or near a bottom of the door assembly 10 as described above relative to spacer 36, although it can also be used in other locations of the door assembly 10.

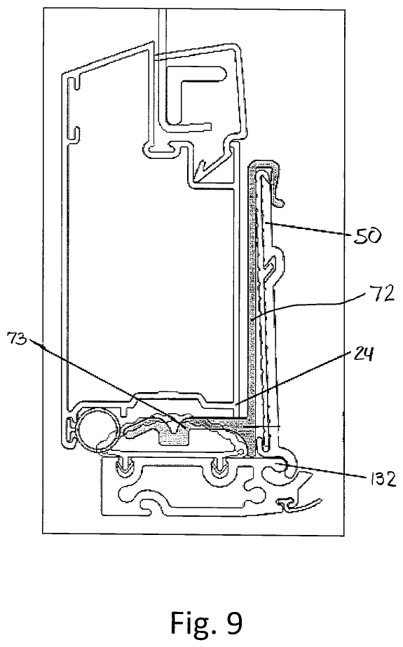

FIG. 9 shows another alternative embodiment of a removable spacer 72. As shown, removable spacer 72 has a “back and forth” shape portion 73 as shown, which may cause removable spacer 72 to have similar or different properties and functional capabilities as compared to removable spacers 36 and 70. Removable spacer 72 is preferably to be used at or near a bottom of the door assembly 10 as described above relative to spacer 36, although it can also be used in other locations of the door assembly 10. These three configurations of spacers 35, 70, 72 are intended to be exemplary, and it is understood that a wide variety of spacer configurations are contemplated that provide the features of maintaining a squareness of a door relative to a frame, particularly prior to and during installation while also engaging with a sill transition to keep it in a desired orientation.

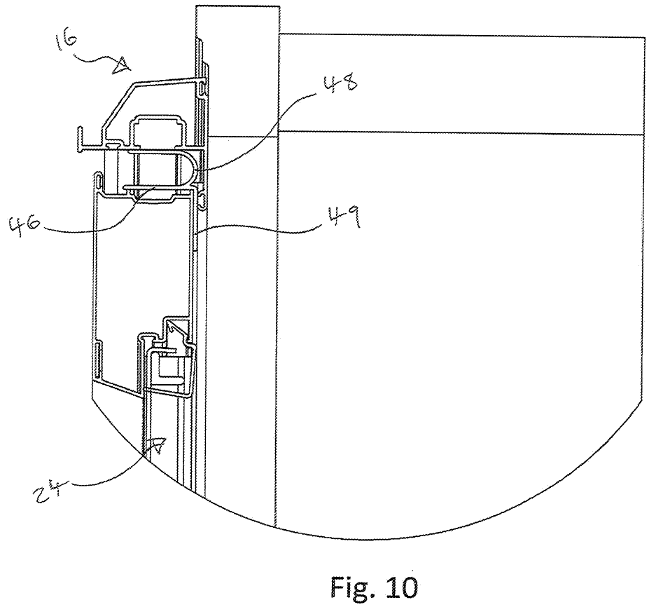

FIG. 10 is a vertical cross-sectional view of the door system of FIG. 1 taken along section line B-B and showing an exemplary embodiment of a second removable spacer 46, according to various embodiments. A second removable spacer 46 can be similar or different to the first removable spacers described above (e.g., spacers 36, 70, 72). However, the second removable spacer 46 can have particular aspects that are different than a first removable spacer. Spacer 46 can be used as a squaring spacer to maintain a squareness of a door relative to a frame to reduce or prevent racking, particularly prior to installation. In some embodiments of ready-to-install door systems, one or more first removable spacers 36 can be supplemented with one or more second removable spacers 46. When used within a door system prior to installation, a spacer 46 can preferably be located near a top of the door and/or frame. Spacers 46 can additionally or alternatively be used on other portions of the door before installation, such as sides and/or bottom of the door.

In an exemplary embodiment, one or more damping spacers can be located between a door panel of the door and a top horizontal bar of the frame or any other suitable location. In some embodiments, the damping spacer can be compressed and/or can compress one or more portion of the door and/or frame.

As described herein, the second removable spacer 46 can be locatable at or near a top of the door assembly 10. The second removable spacer 46 can also include a U-shaped spring portion 48 that gives the second removable spacer 46 flexibility in at least a vertical direction (or longitudinal, depending on the door orientation) for damping, absorption, and/or spring effect. That is, the spacer 46 can be used to dampen impacts, take up manufacturing tolerances, and/or protect adjacent components of a door system before, during, or after shipping, and before or during installation. The damping of the spacer 46 can describe a spring, flexible, compliant, or elastic characteristic, and need not be a purpose-built damper apparatus. The relative rigidity or flexibility of the spacer 46 can be a function of the materials, shape, and/or structural aspects of the damping spacer.

Although the illustrated leaf-spring like U-shaped portion 48 can effectively provide a damping or spring effect, other shapes and configurations are also contemplated herein. A resting shape of an embodiment of a spacer 46 can be a U-shape with a positive angle between two segments of the spacer 46. A substantially flat, positioning flange portion of the spacer 46 can be attached to the U-shaped portion 48, and the positioning portion can be configured to interface with a door and/or frame in order to help hold the spacer 46 in place during shipment and/or installation. The U-shaped portion may include a parallel U-shape, an obtuse U-shape, or an acute U-shape. Although the damping of the spacer 46 can be longitudinal to the door length, a transverse damping or spring function can also be included in the damping spacer.

The second removable spacer 46 can further include a positioning flange 49 that fits next to the door 24 in order to hold the second removable spacer 46 in place prior to installation of the door assembly 10. As shown with further reference to FIG. 11, the second removable spacer 46 can have a natural or resting position and shape with an opening angle that forms non-parallel, open aspect of the U-shaped second removable spacer 46. The open aspect can permit the spring portion 48 to compress when the second removable spacer is inserted or installed in the door assembly 10 prior to shipment or installation. Therefore, as shown in FIG. 10, the second removable spacer 46 can have a vertical compression hereon until released after the door assembly 10 is installed and the second removable spacer is removed. The second removable spacer 46 can apply a force on the horizontal bar 16 and/or the door 24 when installed.

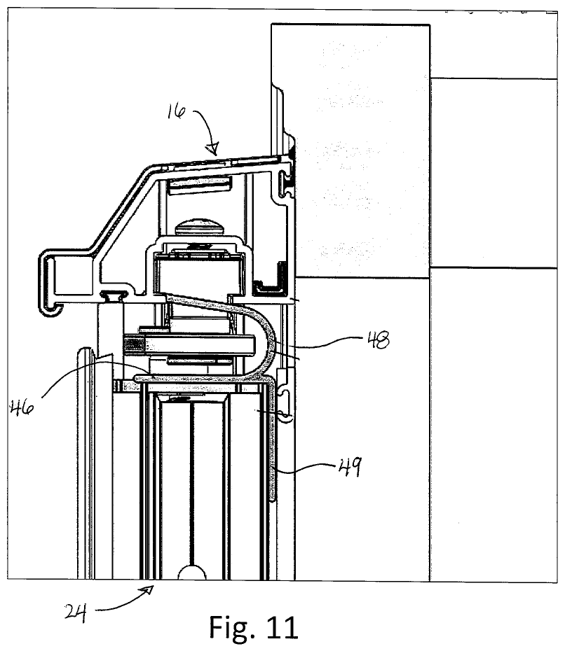

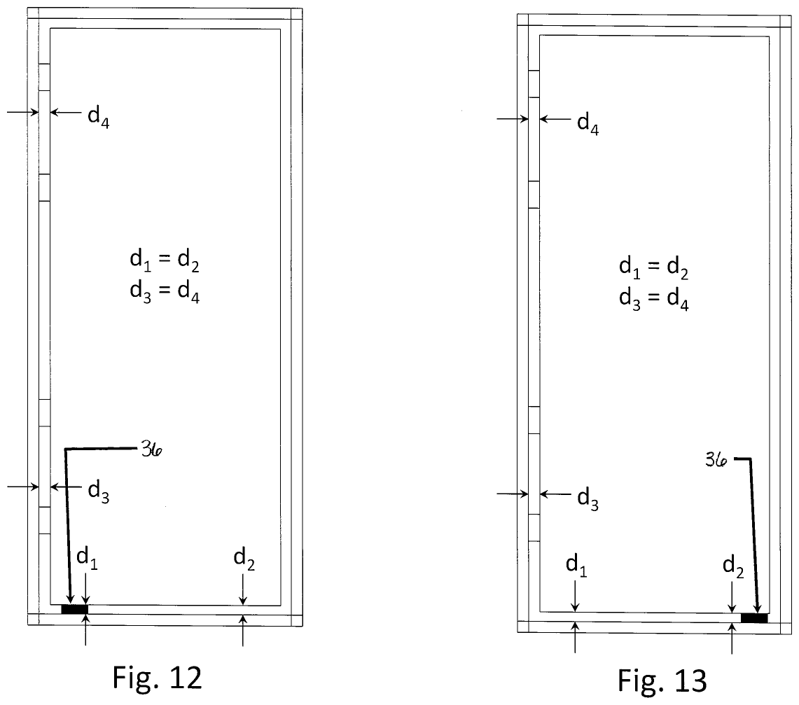

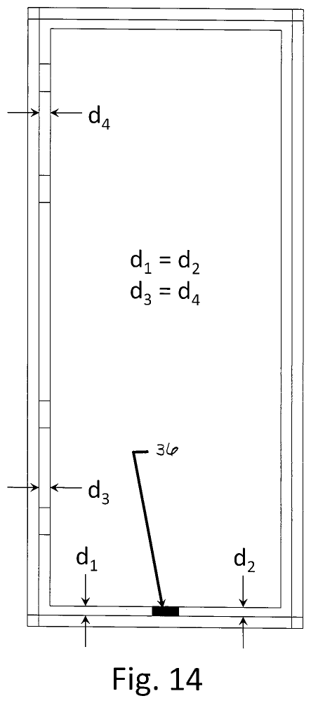

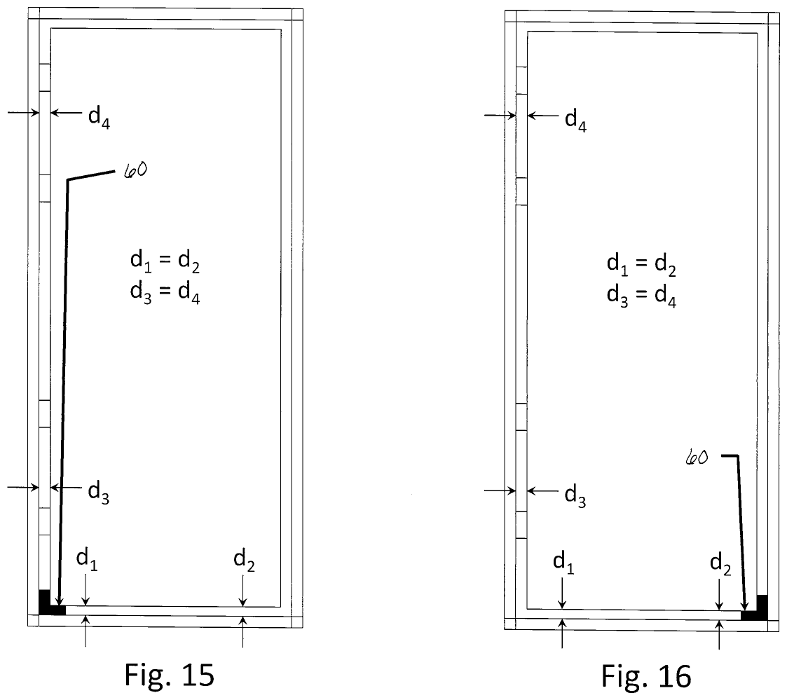

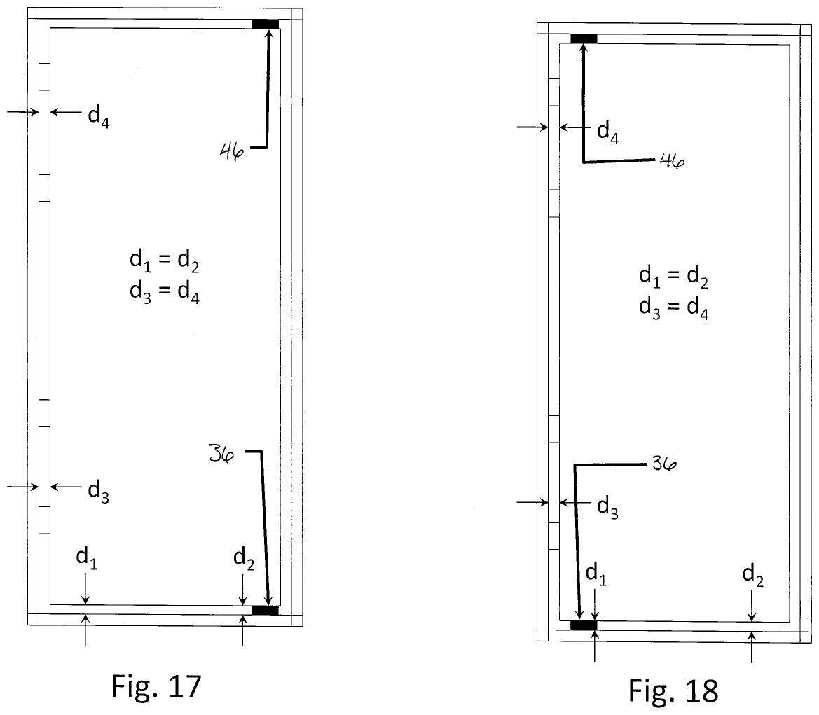

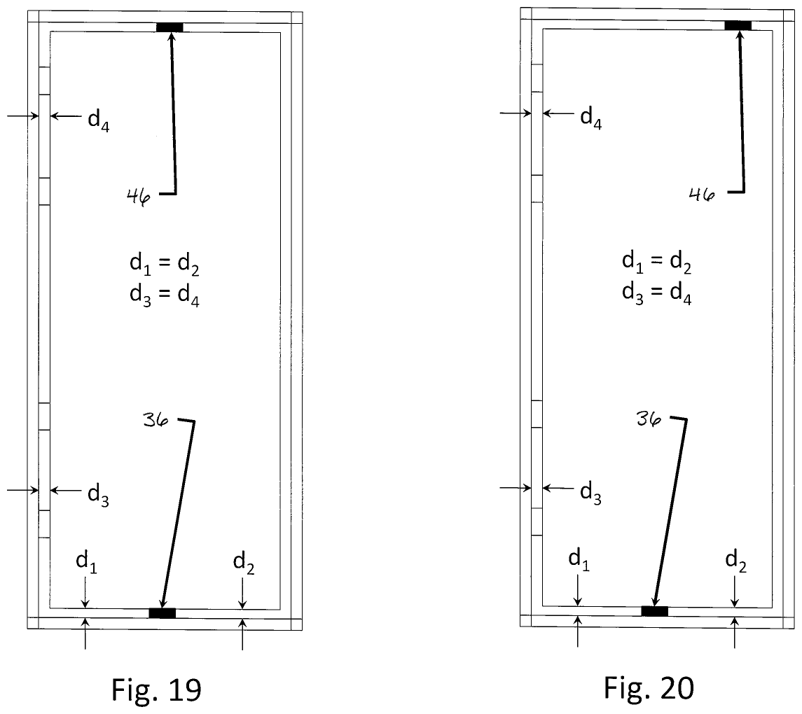

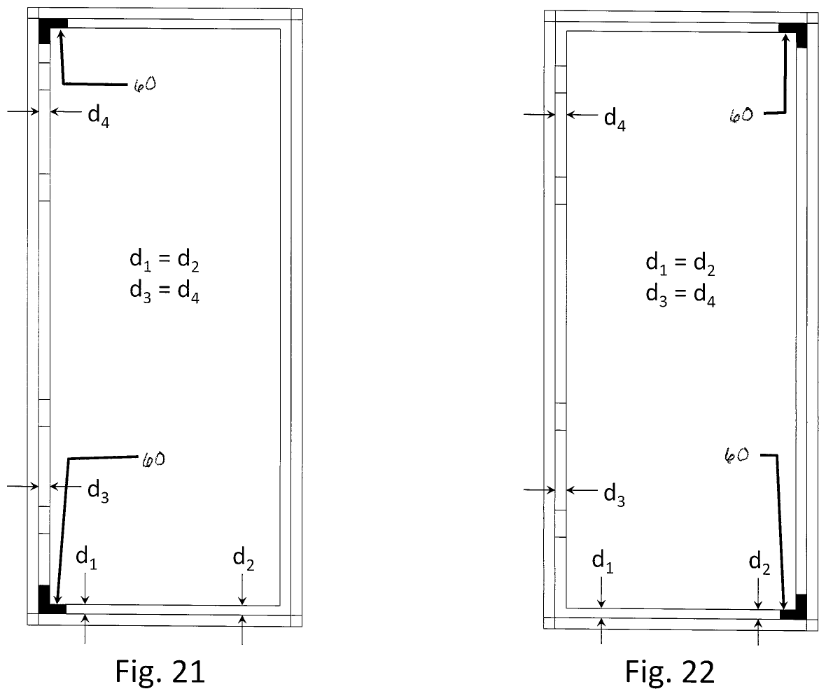

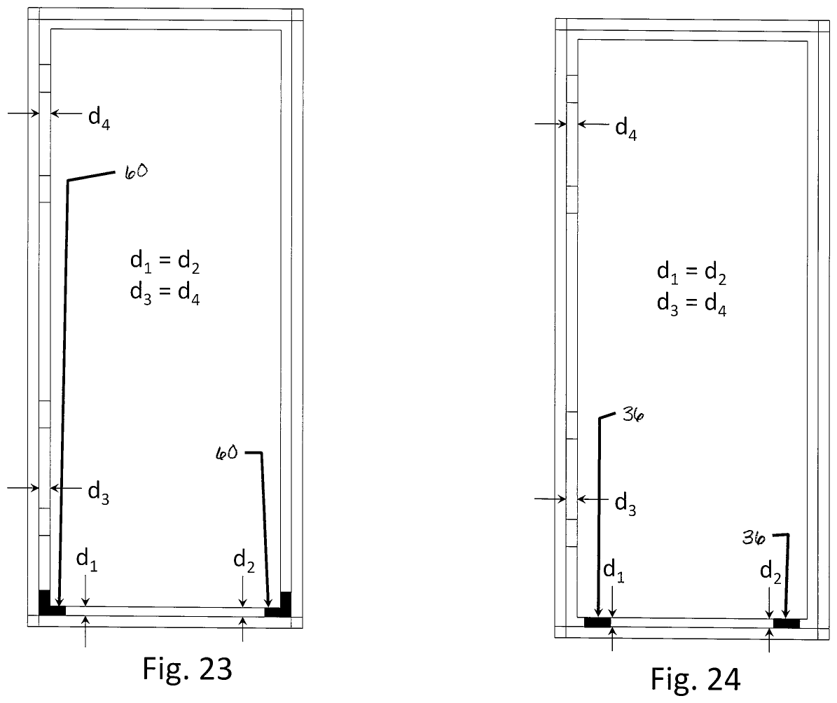

With reference now to FIGS. 12-28, various spacer positions for use in door systems are shown. Furthermore, in some embodiments a squaring spacer is used (alone or in combination with other spacers), and in other embodiments a squaring “corner” spacer 60 is instead used (alone or in combination with other spacers). Corner spacer 60 may have a wide variety of configurations that provide the features of maintaining a squareness of a door relative to a frame, particularly prior to and during installation while also engaging with a sill transition to keep it in a desired orientation

With the exemplary embodiments shown in FIGS. 12-28, although spacers 36, 46, 60 are shown in various numbers and in various locations, other variations, such as different locations, different types, and different arrangements of spacers relative to the door 24 and frame 26 are contemplated.

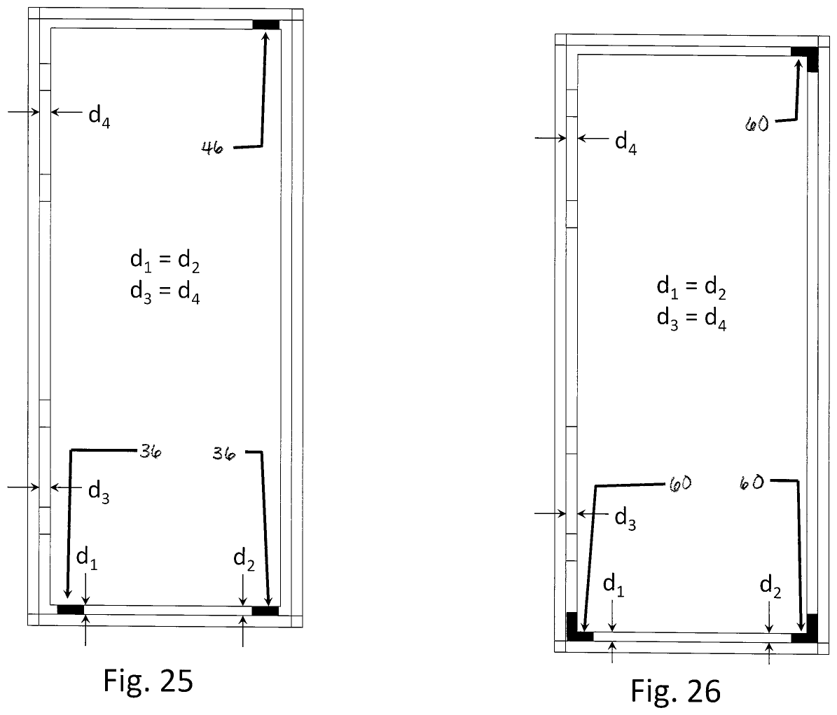

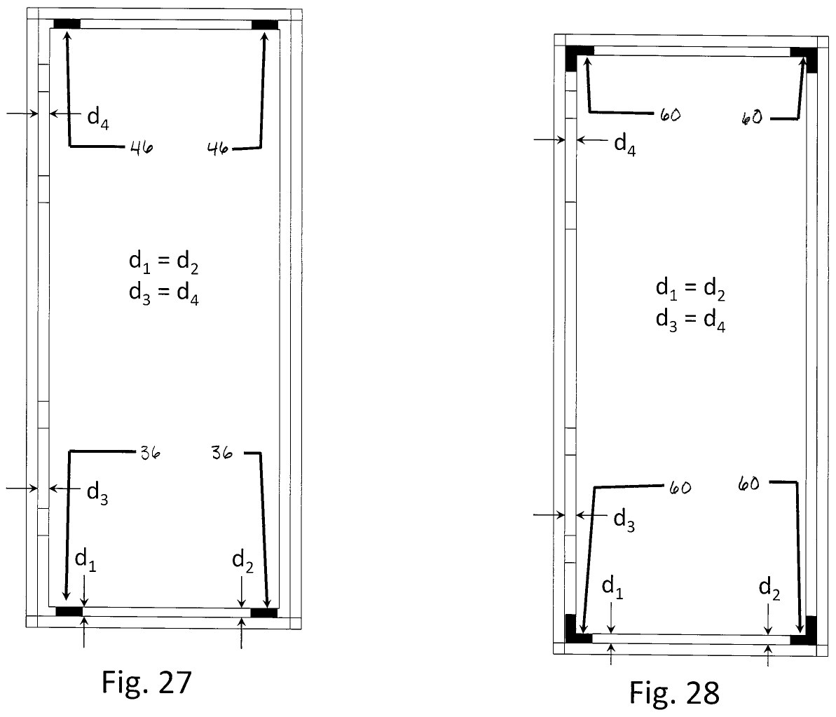

With reference in particular to FIGS. 25 and 26, although three spacers are shown with two spacers 36 or 60 located at a bottom of the door (either corners or otherwise), a single top (e.g., damping) spacer 46 is shown on the latch-side. It is to be understood that the top spacer 46 could be located at the hinge-side in alternative embodiments (or both locations, as shown in FIGS. 27 and 28). In alternative embodiments, a hinge-side and latch-side of the door assembly 10 can be reversed, in which case the positions of the spacers can be correspondingly reversed to provide a similar or equivalent configuration.

All scientific and technical terms used herein have meanings commonly used in the art unless otherwise specified. As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise. As used herein, “have,” “having,” “include,” “including,” “comprise,” “comprising” or the like are used in their open ended sense, and generally mean “including, but not limited to.” It will be understood that the terms “consisting of” and “consisting essentially of” are subsumed in the term “comprising,” and the like.

The present invention has now been described with reference to several embodiments thereof. The entire disclosure of any patent or patent application identified herein is hereby incorporated by reference. The foregoing detailed description and examples have been given for clarity of understanding only. No unnecessary limitations are to be understood therefrom. It will be apparent to those skilled in the art that many changes can be made in the embodiments described without departing from the scope of the invention. Thus, the scope of the present invention should not be limited to the structures described herein, but only by the structures described by the language of the claims and the equivalents of those structures.

We claim:

1. A ready-to-install door system comprising, prior to installation:
a) a frame comprising a hinge-side vertical bar attached at a top end to a horizontal bar that is further attached to a top end of a latch-side vertical bar, and a threshold portion that is attached to a bottom end of the latch-side vertical bar and a bottom end of the hinge-side vertical bar;
b) a door rotatably attached to the hinge-side vertical bar of the frame; and
c) at least one first removable spacer located at a first location of the door between the door and the frame, and configured to at least maintain a desired squareness of the door system prior to installation;
wherein the first removable spacer is configured to be removed after the door system is installed.

2. The ready-to-install door system of claim 1, wherein the at least one first removable spacer is positioned adjacent to the threshold portion of the frame.

3. The ready-to-install door system of claim 1, wherein the at least one first removable spacer is configured to support at least a portion of a weight of the door.

4. The ready-to-install door system of claim 1, further comprising:
at least one second removable spacer located at a second location of the door between the door and the frame and configured to operate in conjunction with the first removable spacer, wherein the second removable spacer is configured to maintain a desired squareness of the door system prior to installation.

5. The ready-to-install door system of claim 4, wherein the at least one second removable spacer is positioned adjacent to the horizontal bar.

6. The ready-to-install door system of claim 4, wherein the at least one second removable spacer is configured to perform at least one of absorbing an impact, taking up tolerances, and protecting adjacent components on the ready-to-install door system prior to installation.

7. The ready-to-install door system of claim 1, wherein the at least one first removable spacer is rigid.

8. The ready-to-install door system of claim 4, wherein the at least one second removable spacer is flexible.

9. The ready-to-install door system of claim 1, wherein the at least one first removable spacer is further configured to engage with a sill transition of the threshold portion of the frame prior to installation.

10. The ready-to-install door system of claim 9, wherein the sill transition is repositionable.

11. The ready-to-install door system of claim 9 wherein the at least one first removable spacer comprises a clip feature configured to hold the sill transition in an installation position prior to installation.

12. The ready-to-install door system of claim 11, wherein the sill transition further comprises a sill extender, and wherein the clip feature is further configured to hold the sill extender in an installation position prior to installation.

13. The ready-to-install door system of claim 1, wherein the at least one first removable spacer is configured to maintain an even, consistent gap between at least a portion of a periphery of the door and a corresponding portion of the frame.

14. The ready-to-install door system of claim 1, wherein the at least one first removable spacer comprises at least a first structural member and a second structural member extending generally from the first structural member, wherein the second structural member is generally perpendicular to an orientation of the first structural member in order to provide structural support in at least two generally perpendicular directions.

15. The ready-to-install door system of claim 4, wherein the at least one second removable spacer has a shape selected from the group consisting of a parallel U-shape, an obtuse U-shape, and an acute U-shape.

16. The ready-to-install door system of claim 1, wherein the at least one first removable spacer is further configured to stabilize at least a portion of the door and frame with respect to each other.

17. The ready-to-install door system of claim 4, wherein the at least one second removable spacer is further configured to stabilize at least a portion of the door and frame with respect to each other.

18. The ready-to-install door system of claim 1, wherein the at least one first removable spacer is further configured to maintain a desired squareness of the door system during at least one of transportation, shipping, and installation.

19. The ready-to-install door system of claim 4, further comprising a third removable spacer.

20. The ready-to-install door system of claim 19, further comprising a fourth removable spacer.

21. A method of installing a ready-to-install door system of claim 1, comprising the steps of:
a) positioning the door system adjacent to or within a frame or trim of a primary door system;
b) attaching the system to the frame or trim of the primary door system;
c) removing at least the first removable spacer.
